(19) United States
(12) Patent Application Publication
(10) Pub. No.: US 2026/0301226 A1
(43) Pub. Date: Oct. 1, 2026

(54) CROSS-CAMERA COLOR CONSTANCY USING CALIBRATED COLOR CORRECTION MATRICES

(71) Applicant: SAMSUNG ELECTRONICS CO., LTD., Suwon-si (KR)

(72) Inventors: Dongyoung KIM, Toronto (CA); Mahmoud Afifi, Toronto (CA); Dongyun Kim, Seoul (KR); Michael Brown, Toronto (CA); Seon Joo Kim, Seoul (KR)

(73) Assignee: SAMSUNG ELECTRONICS CO., LTD., Suwon-si (KR)

(21) Appl. No.: 19/576,895

(22) Filed: Mar. 24, 2026

Related U.S. Application Data
(60) Provisional application No. 63/777,506, filed on Mar. 25, 2025.

(51) Int. Cl. G06T 7/80; G06T 5/40; G06T 5/60; G06T 5/73; G06T 7/90; G06T 11/10

(52) U.S. Cl. CPC G06T 7/80; G06T 5/40; G06T 5/60; G06T 5/73; G06T 7/90; G06T 11/10; G06T 2207/10024; G06T 2207/20084; G06T 2207/20192

(57) ABSTRACT

An electronic device may receive a raw image from a camera and color correction matrices (CCMs) including a first CCM corresponding to a first correlated color temperature and a second CCM corresponding to a second correlated color temperature; generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; convert the raw image into a histogram representation using log-chroma mapping; concatenate the CFE vector with the histogram representation to form a combined feature representation; and estimate an illuminant color in the raw RGB color space of the camera through an illuminant estimation neural network model based on the combined feature representation.

### CROSS-REFERENCE TO RELATED APPLICATIONS

This application claims the benefit of U.S. Provisional Patent Application No. 63/777,506, filed Mar. 25, 2025, the disclosure of which is incorporated herein by reference in its entirety.

### BACKGROUND

Computational color constancy addresses the challenge of maintaining consistent object colors in images captured under varying lighting conditions. In digital cameras, this is achieved through white balancing within the image signal processor (ISP) pipeline, which adjusts raw image colors to simulate neutral lighting. The white balancing process typically involves two stages: estimating the color of the scene's illuminant, and applying a correction that counteracts the effects of the lighting and camera response characteristics. Because these operations occur in the camera's native raw color space, which varies based on sensor spectral sensitivity and lens properties, white balance algorithms are influenced by camera-specific characteristics.

Learning-based approaches to illuminant estimation have demonstrated improved accuracy by training models to map raw image colors to illuminant colors. However, these models are typically trained on paired data captured by specific cameras, causing them to encode sensor-specific characteristics that limit their generalization to cameras with different properties. Adapting such methods to new cameras often requires retraining with newly captured and calibrated data, which can be labor-intensive and impractical at scale. Some approaches have attempted to address cross-camera generalization through techniques such as mapping images to a learned working space or using additional images from the test camera during inference, though these methods may depend on the diversity of training data or the characteristics of additional images provided.

Digital cameras may include pre-calibrated color correction matrices (CCMs) as part of their ISP firmware, which define linear transformations between the camera's native raw color space and device-independent standard color spaces such as CIE XYZ. These CCMs may be calibrated during manufacturing and may be accessible within the ISP and in raw image file formats. Accordingly, there exists an opportunity to leverage such calibrated data to facilitate cross-camera color constancy.

### SUMMARY

According to an aspect of the disclosure, an electronic device may include: a memory storing instructions; and at least one processor configured to execute the instructions to: receive a raw image from a camera and color correction matrices (CCMs) including a first CCM corresponding to a first correlated color temperature and a second CCM corresponding to a second correlated color temperature; generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; convert the raw image into a histogram representation using log-chroma mapping; concatenate the CFE vector with the histogram representation to form a combined feature representation; and estimate an illuminant color in the raw RGB color space of the camera through an illuminant estimation neural network model based on the combined feature representation.

A method for cross-camera color constancy, may include: receiving a raw image from a camera and color correction matrices (CCMs) including a first CCM corresponding to a first correlated color temperature and a second CCM corresponding to a second correlated color temperature; generating a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; converting the raw image into a histogram representation using log-chroma mapping; concatenating the CFE vector with the histogram representation to form a combined feature representation; and estimating an illuminant color in the raw RGB color space of the camera through an illuminant estimation neural network based on the combined feature representation.

A non-transitory computer-readable storage medium storing instructions that, when executed by at least one processor, may cause the at least one processor to: receive a raw image from a camera and color correction matrices (CCMs) including a first CCM corresponding to a first correlated color temperature and a second CCM corresponding to a second correlated color temperature; generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; convert the raw image into a histogram representation using log-chroma mapping; concatenate the CFE vector with the histogram representation to form a combined feature representation; and estimate an illuminant color in the raw RGB color space of the camera through an illuminant estimation neural network model based on the combined feature representation.

### BRIEF DESCRIPTION OF DRAWINGS

Further features, the nature, and various advantages of the disclosed subject matter will be more apparent from the following detailed description and the accompanying drawings in which:

FIG. 1 illustrates a block diagram of a cross-camera color constancy system, according to one or more embodiments of the present disclosure.

FIG. 2 illustrates a block diagram of a camera fingerprint embedding (CFE) encoder, according to one or more embodiments of the present disclosure.

FIG. 3 illustrates a block diagram of a hypernetwork with an encoder and decoder branches, according to one or more embodiments of the present disclosure.

FIG. 4 illustrates a flowchart of a method for performing cross-camera color constancy, according to one or more embodiments of the present disclosure.

FIG. 5 illustrates a block diagram of an electronic device configured to implement cross-camera color constancy, according to one or more embodiments of the present disclosure.

FIG. 6 illustrates a block diagram of a cross-camera color constancy system using a direct illuminant estimation network, according to one or more embodiments of the present disclosure.

FIG. 7 illustrates a flowchart of a method for illuminant estimation using a direct illuminant estimation network, according to one or more embodiments of the present disclosure.

FIG. 8 illustrates a block diagram of a cross-camera color constancy system with two parallel processing paths, according to one or more embodiments of the present disclosure.

FIG. 9 illustrates a flowchart of a method for cross-camera color constancy using selectable processing paths, according to one or more embodiments of the present disclosure.

FIG. 10 illustrates a network diagram of devices for performing cross-camera color constancy, according to one or more embodiments of the present disclosure.

FIG. 11 illustrates a block diagram of components of one or more devices of FIG. 10, according to one or more embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure relate to a cross-camera color constancy system and method that estimates the color of a scene's illuminant from a raw image captured by a camera, and that adapts to cameras with different spectral characteristics without requiring retraining or additional images from the camera. The cross-camera color constancy system may use pre-calibrated color correction matrices (CCMs), which are available in camera image signal processors (ISPs) and raw image file formats, to generate a compact camera-specific representation that guides an illuminant estimation process.

The cross-camera color constancy system may generate a camera fingerprint embedding (CFE) by using the camera's CCMs to transform a set of known reference illuminant colors from a standard color space into the camera's own raw color space. Because different cameras perceive the same reference illuminants differently due to their unique sensor characteristics, the resulting transformed illuminant colors form a distinctive pattern that serves as a fingerprint for each camera. This fingerprint may be encoded into a compact vector and combined with a histogram of an input image, allowing a single trained model to produce accurate illuminant estimates for any camera, including cameras not seen during training.

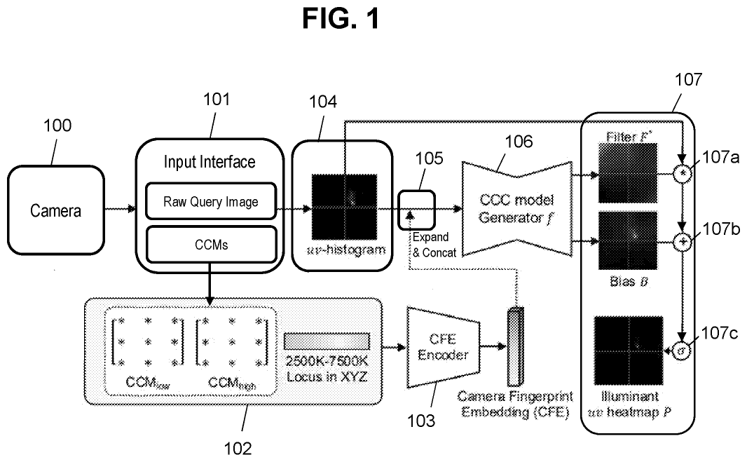

FIG. 1 illustrates a block diagram of a cross-camera color constancy system in one or more embodiments of the present disclosure.

Referring to FIG. 1, a block diagram of a cross-camera color constancy system is illustrated. The cross-camera color constancy system, which may be referred to as CCMNet, is a neural network framework for cross-camera color constancy that may generalize to unseen camera sensors without requiring retraining. The cross-camera color constancy system may include a camera 100, an input interface 101, a CCM-based illuminant trajectory generator 102, a CFE encoder 103, an image histogram converter 104, a concatenation and feature conditioning module 105, a hypernetwork 106, and an illuminant estimation module 107. The hypernetwork 106 may be also referred to as a CCC model generator.

The input interface 101 may receive a raw query image from the camera 100 (or an image sensor included in the camera 100) along with color correction matrices (CCMs). In some cases, the input interface 101 may receive a CCM for low correlated color temperature (CCM_{low}) and a CCM for high correlated color temperature (CCM_{high}). The CCM_{low} and CCM_{high} may correspond to color temperatures of approximately 2500K and 6500K, respectively. The CCM for low correlated color temperature (CCM_{low}) may also be referred to as a first CCM corresponding to a first correlated color temperature, and the CCM for high correlated color temperature (CCM_{high}) may also be referred to as a second CCM corresponding to a second correlated color temperature higher than the first correlated color temperature. The camera 100 may include pre-calibrated CCMs as part of its image signal processor (ISP) firmware. The CCMs may define a linear transformation from the camera-specific raw RGB space to a device-independent standard color space such as CIE XYZ. The CIE XYZ color space is one example of a device-independent color space. In some embodiments, other device-independent color spaces, such as CIE Lab or linear sRGB, may be used in place of the CIE XYZ color space. The CCMs may be calibrated during manufacturing and may be accessible within the ISP and in raw image file formats such as DNG files. In some embodiments, no additional images from the test camera are required beyond the single raw query image.

With continued reference to FIG. 1, the CCM-based illuminant trajectory generator 102 may receive the CCMs from the input interface 101 and may convert a predefined set of illuminant chromaticities along the Planckian locus from the CIE XYZ color space into the native raw RGB color space of the camera. In some cases, the illuminant chromaticities may be sampled at regular intervals (e.g., with a sampling rate of 100K) within a color temperature range of 2500K to 7500K. In some aspects, 51 colors ranging from 2500K to 7500K may be used as guidance illuminants. The CCM-based illuminant trajectory generator 102 may use interpolation between the CCM_{low} and CCM_{high} to compute a transformation matrix CCMₜ for a target color temperature t. The interpolation may be defined as:

$$C C {M}_{t} = g \cdot CC {M}_{l o w} + ( 1 - g ) \cdot CC {M}_{h i g h} \qquad Eq . ( 1 )$$

where g is an interpolation weight defined as:

$$g = \frac{{t}^{- 1} - C C {T}_{h i g h}^{- 1}}{C C {T}_{l o w}^{- 1} - C C {T}_{h i g h}^{- 1}} \qquad Eq . ( 2 )$$

Referring to Equation (2), to obtain the interpolation weight g, the CCM-based illuminant trajectory generator 102 may receive the target color temperature t and the reference color temperatures CCT_{low} and CCT_{high} as inputs. The CCM-based illuminant trajectory generator 102 may compute the reciprocal of each color temperature value, subtract the reciprocal of CCT_{high} from the reciprocal of t in the numerator, and subtract the reciprocal of CCT_{high} from the reciprocal of CCT_{low} in the denominator. The CCM-based illuminant trajectory generator 102 may then divide the numerator by the denominator to produce the interpolation weight g. The output may be a scalar value g between 0 and 1 that determines the relative contribution of CCM_{low} and CCM_{high} in the interpolation.

The embodiments described above use two CCMs (CCM_{low} and CCM_{high}) for interpolation, but the cross-camera color constancy system is not limited thereto. In some embodiments, the CFE may be generated using three or more CCMs. With three or more CCMs, the interpolation may be generalized using multi-point interpolation techniques, such as piecewise linear interpolation, spline interpolation, or low-order polynomial regression over the reciprocal of the correlated color temperature, to obtain a transformation matrix for any target color temperature.

Some camera pipelines may support more than two calibration illuminants. For example, some raw image file specifications may define triple-illuminant camera profiles that provide three color correction matrices corresponding to three distinct reference illuminants. In such cases, the cross-camera color constancy system may estimate the scene's correlated color temperature, identify the two nearest calibration points among the three, and perform piecewise interpolation between those two matrices.

Referring to Equation (1), in order to obtain the transformation matrix CCMₜ, the CCM-based illuminant trajectory generator 102 may receive the CCM_{low} and CCM_{high} matrices along with the interpolation weight g as inputs. The CCM-based illuminant trajectory generator 102 may multiply each matrix element of CCM_{low} by the weight g and each matrix element of CCM_{high} by (1-g), and may then sum the corresponding elements to produce the interpolated CCMₜ matrix. The output may be a 3×3 transformation matrix CCMₜ that may be appropriate for the target color temperature t.

Each sampled XYZ coordinate I_{XYZ,t} corresponding to an illuminant at color temperature t may then be transformed into a camera-native RGB color vector I_{RGB,t} using the equation:

$${I}_{RGB , t} = C C {M}_{t} \cdot {I}_{X YZ , t} \qquad Eq . ( 3 )$$

In operation, the CCM-based illuminant trajectory generator 102 may obtain the interpolated transformation matrix CCMₜ and the XYZ coordinates I_{XYZ,t} of an illuminant. The CCM-based illuminant trajectory generator 102 may perform matrix multiplication between the transformation matrix CCMₜ (e.g., a 3×3 transformation matrix CCMₜ) and the XYZ coordinate vector (e.g., a 3×1 XYZ coordinate vector). The CCM-based illuminant trajectory generator 102 may obtain the camera-native RGB color vector I_{RGB,t} (e.g., a 3×1 vector, I_{RGB,t}=[_{R}, I_{G}, I_{B}]^{T}) representing a camera-native RGB response of the camera 100 to an illuminant at color temperature t.

The CCM-based illuminant trajectory generator 102 may transform the camera-native RGB color vector I_{RGB,t} into a uv-histogram using Equations (4) and (5).

For the camera-native RGB color vector I_{RGB,t}=[I_{R}, I_{G}, I_{B}]^{T}, log-chroma values Iᵤ and Iᵥ may be calculated as:

$${I}_{u} = log ( {I}_{G} / {I}_{R} ) , {I}_{v} = log ( {I}_{G} / {I}_{B} ) \qquad Eq . ( 4 )$$

In operation, the CCM-based illuminant trajectory generator 102 may compute a ratio Iᵤ of a green channel value I_{G} to a red channel value I_{R} and apply a logarithm function to produce the u coordinate. Similarly, the image histogram converter 104 may compute a ratio I_{G} of the green channel value I_{G} to the blue channel value I_{B} and apply a logarithm function to produce the v coordinate. The output may be the log-chroma coordinates (u, v) for each pixel, which represent the chromaticity of the pixel in a logarithmic color space.

A uv-histogram may then be generated as:

$$N ( u , v ) = {\sum }_{x} {\vert {I}^{x} \vert}_{2} [ \vert {I}_{u}^{x} - u \vert \leq ε ∧ \vert {I}_{v}^{x} - v \vert \leq ε ] \qquad Eq . ( 5 )$$

Where x indexes pixel in the image, E denotes a histogram bin width, and |I^{x}|₂ is a weighting factor for each pixel defined as the L2 norm of the raw RGB values. Accordingly, N(u, v) represents a weighted count of pixels in image I that fall within a certain range (ε) around a location (u, v). In some cases, the uv-domain ranges for the histograms may be [−0.5, 1.5] for CFE encoding.

During histogram construction, the CCM-based illuminant trajectory generator 102 may receive the log-chroma coordinates

$$( {I}_{u}^{x} , {I}_{v}^{x} )$$

and corresponding L2 norm weights for all pixels. For each histogram bin centered at location (u, v), the CCM-based illuminant trajectory generator 102 may determine whether each pixel's log-chroma coordinates fall within the bin boundaries defined by ε. For pixels that fall within the bin, the CCM-based illuminant trajectory generator 102 may accumulate their L2 norm weights, and may output a two-dimensional histogram N(u, v) where each bin contains the weighted count of pixels whose chromaticity falls within that bin's range.

The CFE encoder 103 may process the output from the CCM-based illuminant trajectory generator 102 to generate a camera fingerprint embedding. As used herein, a camera fingerprint embedding (CFE) may refer to a compact vector representation that encodes spectral response characteristics of a specific camera by capturing how the camera perceives a range of standard illuminants in its native raw color space. The CFE may enable a neural network model to adapt to unseen cameras by providing camera-specific guidance without requiring retraining or additional images from the camera.

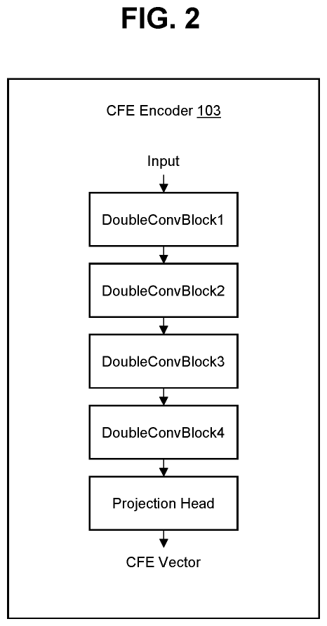

The CFE encoder 103 may encode spectral response characteristics of the camera 100 into a compact representation. In some cases, the CFE encoder 103 may receive a 64×64×1 uv-histogram of guidance illuminants as input. The CFE encoder 103 may include a lightweight convolutional neural network (CNN)-based encoder that produces an 8-dimensional CFE vector. The CFE encoder 103 may include four DoubleConvBlocks followed by a projection head. For example, each DoubleConvBlock may process an input by applying two convolutional layers, each with a kernel size of 3×3, a stride of 1, and a padding of 1, followed by a LeakyReLU activation, a 2×2 max-pooling layer, and batch normalization. The four DoubleConvBlocks may progressively extract features while reducing spatial dimensions. The projection head may flatten or compress a feature map from the last DoubleConvBlock and map it to an 8-dimensional embedding vector using a multi-layer perception (MLP) with two hidden layers. The CFE encoder 103 may output a CFE vector that captures unique color characteristics of the camera 100. The CFE may be fixed for each camera and may only need to be extracted once at testing time. An example structure of the CFE encoder 103 is described later with reference to FIG. 2.

As further shown in FIG. 1, the image histogram converter 104 may receive the raw query image from the input interface 101 and may convert the raw query image into a uv-histogram representation using log-chroma mapping. Unlike the CCM-based illuminant trajectory generator 102, which generates a uv-histogram encoding a camera-dependent prior derived from calibration data and illuminant physics, the image histogram converter 104 may compute log-chroma coordinates directly from the input raw image pixels and bins them into uv-histograms that encode scene evidence based on pixel statistics of the captured image. As used herein, log-chroma mapping refers to a transformation that converts raw RGB pixel values into a logarithmic chromaticity space by computing the logarithm of ratios between color channels.

For an image's RGB pixel [I_{R}, I_{G}, I_{B}], the image histogram converter 104 may calculate log-chroma values Iᵤ and Iᵥ using Equation (4), and may generate a uv-histogram using Equation (5) based on the log-chroma values Iᵤ and Iᵥ. In some cases, uv-ranges for the uv-histogram may be empirically set to [−2.85, 2.85] for the raw query image.

The uv-histogram is one example of a histogram representation that may be used. In some embodiments, any histogram representation that captures the chromaticity distribution of the image in a log-chroma space or other suitable color space may be used in place of the uv-histogram.

In one or more embodiments, an edge-enhanced version of the raw query image may be generated by applying an edge detection or edge enhancement operation to the raw query image. The edge enhancement operation may include applying high-pass filtering, a gradient-based filter, such as a Sobel filter, a Prewitt/Scharr filter, a Laplacian filter, a Canny edge detector, or other edge detection operators, to the raw query image to produce an edge-enhanced image in which edge features are emphasized. The edge-enhanced version may capture structural and boundary information in the raw query image that may complement the chromaticity information captured by the original image histogram. In some cases, the image histogram converter 104 may also convert the raw query image into a first uv-histogram and convert an edge-enhanced image into a second uv-histogram, thereby producing histograms N₀ and N₁.

The concatenation and feature conditioning module 105 may receive the uv-histogram from the image histogram converter 104 and the CFE vector from the CFE encoder 103. The concatenation and feature conditioning module 105 may expand the CFE vector by repeating it along the u and v axes to match a resolution of the uv-histogram received from the image histogram converter 104. The expanded CFE vector may then be concatenated with the uv-histogram along a channel dimension to form combined features.

With continued reference to FIG. 1, the hypernetwork 106, which may be labeled as convolutional color constancy (CCC) model generator f, may receive the combined features from the concatenation and feature conditioning module 105 and may generate a filter F and a bias B. In some cases, the hypernetwork 106 may generate multiple filters F₀ and F₁ corresponding to histograms derived from the raw query image and the edge-enhanced image. The outputs of the hypernetwork 106, such as the filter F, F₀, and F₁ and the bias B, may be used to generate a probability heatmap over the uv space that reflects the most likely illuminant chromaticity.

The hypernetwork 106 may include an encoder-decoder network with a U-Net structure. In the encoder-decoder network, an encoder may progressively downsample input features while extracting hierarchical representations. In the encoder-decoder network, decoders may upsample the features back to the original resolution. Skip connections may preserve spatial information from the encoder to help the decoders generate accurate filters and bias.

The hypernetwork 106 may also be referred to as a CCC model generator that processes input histograms concatenated with the CFE vector to produce filters and bias for an image-specific convolutional color constancy (CCC) model. In some embodiments, the hypernetwork 106 may use a modified architecture with a single encoder and two decoders, where one decoder may be configured to generate the filters and another decoder may be configured to generate the bias. The encoder and decoders may be connected via skip connections.

In some cases, the encoder of the hypernetwork 106 may consist of four blocks. Each encoder block may comprise interleaved 3×3 convolutional layers, leaky ReLU activation, batch normalization, and 2×2 max pooling. The encoder may receive the concatenated features, including the histograms and the CFE feature, as input. The encoder may progressively downsample the input features while extracting hierarchical representations at multiple scales.

Each decoder of the hypernetwork 106 may include multiple decoder blocks. Each decoder block may include 2× bilinear upsampling followed by interleaved 3×3 convolutional layers, leaky ReLU activation, and instance normalization. The decoders may upsample the features back to the original resolution of the input histograms. Skip connections may connect encoder blocks to corresponding decoder blocks at matching resolutions, which may preserve spatial information from the encoder to help the decoders generate accurate filters and bias.

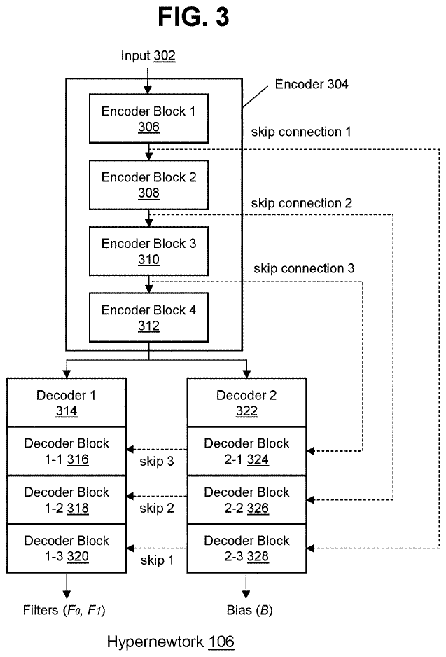

In operation, the hypernetwork 106 may receive the concatenated features from the concatenation and feature conditioning module 105 as input. The encoder may process the input through its four blocks, producing feature maps at progressively lower resolutions. At each encoder block, the feature maps may be stored for use by the skip connections. The first decoder may receive the encoded features and upsample them through its decoder blocks while incorporating the stored feature maps via skip connections, ultimately outputting the filters F₀ and F₁. The second decoder may similarly receive the encoded features and upsample them through its decoder blocks while incorporating the stored feature maps via skip connections, ultimately outputting the bias B. The filters and bias may have the same spatial dimensions as the input uv-histograms. An example structure of the hypernetwork 106 is described below with reference to FIG. 3.

Referring to FIG. 1, the illuminant estimation module 107 may receive the filter F and bias B from the hypernetwork 106, and the uv-histogram from the image histogram converter 104. The illuminant estimation module 107 may apply an convolution operation 107a to the uv-histogram and the filter F to obtain a feature map as a convolution result, and apply an addition operation 107b to the feature map and the bias B to obtain a biased feature map. The illuminant estimation module 107 may apply a softmax operation 107c to the biased feature map to produce an illuminant uv heatmap P. The illuminant uv heatmap P may be generated using the equation:

$$P = σ ( B + {\sum }_{i} ( {N}_{i} * {F}_{i} ) ) \qquad Eq . ( 6 )$$

where Nᵢ represents the uv-histogram received from the image histogram converter 104, * represents the convolution operation 107a, and σ represents the softmax operation 107c over the uv-coordinate space. The illuminant uv heatmap P may be a confidence map for each (u, v) coordinate i. The softmax operation 107c is one example of a normalization operation that produces a probability distribution over the uv-coordinate space. In some aspects, other normalization operations that produce a probability distribution may be used in place of the softmax operation, such as a sigmoid function followed by L1 normalization, a sparsemax operation, or any other operation that normalizes the output values to sum to one across the spatial dimensions.

The hypernetwork 106 and the illuminant estimation module 107 may collectively be referred to as an illuminant estimation neural network model.

In operation, the illuminant estimation module 107 may receive the uv-histograms Nᵢ, the filters Fᵢ, and the bias B as inputs. For each histogram-filter pair, the illuminant estimation module 107 may perform a convolution operation by sliding the filter across the histogram and computing the element-wise product and sum at each position. The illuminant estimation module 107 may then sum the convolution results from all histogram-filter pairs and add the bias term B. Finally, the illuminant estimation module 107 may apply a softmax operation across all (u, v) coordinates to normalize the values into a probability distribution. The output may be the illuminant uv heatmap P representing the likelihood of each (u, v) coordinate being the illuminant chromaticity.

The final prediction (\hat{l}ᵤ, \hat{l}ᵥ) may be expressed as a weighted sum of the coordinates using the illuminant uv heatmap P:

$${\hat{l}}_{u} = {\sum }_{u , v} u \cdot P ( u , v ) , {\hat{l}}_{v} = {\sum }_{u , v} v \cdot P ( u , v ) \qquad Eq . ( 7 )$$

For each (u, v) coordinate in the illuminant uv heatmap P, the illuminant estimation module 107 may multiply a u coordinate value u by the probability P(u, v) at that location and accumulate the products to compute an expected u coordinate \hat{l}ᵤ. Similarly, the illuminant estimation module 107 may multiply a v coordinate value v by the probability P(u, v) and accumulate the products to compute an expected v coordinate \hat{l}ᵥ. The illuminant estimation module 107 may obtain estimated illuminant chromaticity coordinates (\hat{l}ᵤ, \hat{l}ᵥ) representing the weighted average of all coordinates based on their probabilities.

The illuminant estimation module 107 may then output the estimated illuminant color in the camera's native raw RGB space. The final RGB illumination estimate \hat{l} may be obtained by inverting the log-chroma transformation:

$$\hat{l} = [ exp ( - {\hat{l}}_{u} ) , 1 , exp ( - {\hat{l}}_{v} ) ] \qquad Eq . ( 8 )$$

where a green channel may be assumed to be G=1. Alternatively, \hat{l} may be normalized to ensure that the vector has unit length.

In operation, the illuminant estimation module 107 may process the estimated log-chroma coordinates (\hat{l}ᵤ, \hat{l}ᵥ) to output the final RGB illumination estimate \hat{l}. The illuminant estimation module 107 may negate the \hat{l}ᵤ value and apply an exponential function to produce a red channel component of the illuminant. The illuminant estimation module 107 may set a green channel component to 1. The illuminant estimation module 107 may negate the \hat{l}ᵥ value and apply an exponential function to produce a blue channel component of the illuminant. The output may be the final estimated illuminant color \hat{l} as an RGB vector in the camera's native raw color space.

In some aspects, the cross-camera color constancy system may provide cross-camera color constancy while remaining lightweight. The CFE feature may be fixed once the camera device is determined, and may only need to be extracted once for a new camera and reused thereafter. As a result, the size and computational cost of the cross-camera color constancy system may be determined based on the hypernetwork 106, making it suitable for integration into ISP modules where efficient resource utilization may be beneficial.

In some aspects, the cross-camera color constancy system may include an imaginary camera augmentation strategy to enhance the diversity of camera characteristics during training. In prior illuminant estimation work, most data augmentation techniques rely on transferring ground-truth illuminant colors to other images within the same dataset using chromatic adaptation. However, this approach may be incompatible with methods trained on raw images captured by different cameras, each with distinct raw color spaces. To overcome these limitations, virtual cameras may be synthesized by leveraging the CCMs of available training cameras. This may broaden the range of camera raw spaces encountered during training, thereby improving generalization. Under the assumption of a single illuminant in the scene, the value of channel c ∈ {R, G, B} at pixel x in the camera's raw space may be expressed as:

$${I}_{c} ( x ) = \int S ( λ , x ) R ( λ ) {Q}_{c} ( λ ) d λ \qquad Eq . ( 9 )$$

where S(⋅) and R(⋅) represent a spectral power distribution of the scene and illuminant at pixel x, respectively, and Q_{c} is the camera's spectral sensitivity for color channel c. The integral may be computed over λ, which corresponds to wavelengths in a visible light spectrum.

In operation, a processor of the cross-camera color constancy system may model an image formation process where the pixel value for each color channel c is computed as an integral over visible wavelengths. The processor may receive the spectral power distribution of the scene S(λ, x), the spectral power distribution of the illuminant R(λ), and the camera's spectral sensitivity Q_{c}(λ) as inputs. For each wavelength λ in the visible spectrum, the processor may multiply these three spectral functions together and integrate the product over all wavelengths. The output may be the pixel value I_{c}(x) for color channel c at pixel location x in the camera's native raw color space.

$${I}_{c}^{A} = \int S ( λ ) R ( λ ) ( α {Q}_{c}^{A} + ( 1 - α ) {Q}_{c}^{B} ) ( λ ) d λ {I}_{c}^{V} = α {I}_{c}^{A} + ( 1 - α ) {I}_{c}^{B} \qquad Eq . ( 10 )$$

where superscripts A, B, and V denote different cameras, including the virtual camera, and α ∈ [0,1]controls the contribution of each camera to the synthesized virtual camera. Since characteristics of the camera may be defined by their respective functions Q, an image captured by a virtual camera V may be approximated by linearly combining the characteristics of cameras A and B with a ratio α.

The ratio α may also be referred to as a blending ratio that determines the relative weighting of images from two different cameras in the linear combination. In some embodiments, the blending ratio α may be sampled uniformly from the range [0, 1] to maximize the diversity of synthesized virtual cameras. In some embodiments, the blending ratio α may be biased toward the endpoints of the range (near 0 or 1) to emphasize realistic camera characteristics while still introducing controlled variability. In some embodiments, the blending ratio used to derive the color correction matrices for the virtual camera may be the same blending ratio used to generate the synthesized virtual camera images, such that both the images and the color correction matrices of the virtual camera are derived using a consistent weighting of the two different cameras.

Since CCMNet may require CCMs to encode CFE, it may derive CCMs for the virtual camera. The CCM_{low} for the virtual camera V may be defined as:

$$C C {M}_{l o w}^{V} = α \cdot CC {M}_{l o w}^{A} + ( 1 - α ) \cdot CC {M}_{l o w}^{B} \qquad Eq . ( 11 )$$

In operation, the processor may receive the CCM_{low} matrices from cameras A and B, along with the blending ratio α as inputs. For each element in the CCM_{low} matrices, the processor may multiply the corresponding element from camera A's CCM_{low} by a and multiply the corresponding element from camera B's CCM_{low} by (1-α). The processor may then sum these weighted values to produce the corresponding element in the virtual camera's CCM_{low} matrix. The output may be a synthesized CCM_{low} matrix for the virtual camera V that can be used to encode the CFE for the virtual camera. In some aspects, the blending ratio used to derive the color correction matrices for the virtual camera may be the same blending ratio used to generate the synthesized virtual camera images, such that both the images and the color correction matrices of the virtual camera are derived using a consistent weighting of the two different cameras

This relationship may also hold for CCT_{high} and any arbitrary color temperature t within the range of low and high CCTs in the calibrated CCMs. The augmented images and CCMs may approximate the spectral sensitivity of the virtual camera, helping the CFE encoder generalize to a wider range of cameras despite the limited number of training cameras.

In one or more embodiments of the present disclosure, training of the hypernetwork 106 may be performed on paired raw images with ground-truth illuminants captured by multiple cameras. The training objective may be to optimize the hypernetwork 106 to minimize an angular error between a predicted illumination RGB and a ground-truth illumination in a training dataset. The imaginary camera augmentation described with reference to Equations (10) and (11) may be applied during training to improve accuracy and generalization.

In one or more embodiments, the illuminant estimation neural network model may include an illuminant estimation network configured to directly predict an illuminant color in the camera's native raw RGB space from the combined features, without generating intermediate filters or bias.

In one or more embodiments, the illuminant estimation neural network model may include two processing paths: a first path configured to predict CCC model weights (filters and bias) used to estimate a final illuminant color, and a second path configured to directly predict an illuminant color in the camera's native raw RGB space, thereby providing complementary information that improves the accuracy of illuminant estimation.

FIG. 2 illustrates a block diagram of a CFE encoder according to one or more embodiments of the present disclosure.

Referring to FIG. 2, a block diagram illustrating an example structure of the CFE encoder 103 is shown. The CFE encoder 103 may receive a 64×64×1 uv-histogram of guidance illuminants as input. The CFE encoder 103 may be implemented as any lightweight network that maps a fixed-resolution uv-histogram into a compact embedding. The architecture described herein with reference to FIG. 2 is one example instantiation, and embodiments of the present disclosure are not limited to the specific architecture shown. Alternative implementations may include different numbers of convolutional layers, different activation functions, different pooling strategies, or other network architectures that produce a compact embedding from the input histogram.

The CFE encoder 103 may include a plurality of DoubleConvBlocks arranged sequentially. As used herein, a DoubleConvBlock refers to a convolutional block that applies two sequential convolutional layers to the input, where each convolutional layer may be followed by an activation function. In some cases, the CFE encoder 103 may include four DoubleConvBlocks, though embodiments of the present disclosure are not limited thereto and any suitable number of convolutional blocks may be used. Furthermore, embodiments of the present disclosure are not limited to convolutional blocks having two convolutional layers, and each convolutional block may include any suitable number of convolutional layers. Each DoubleConvBlock may process the input by applying two convolutional layers, each with a kernel size of 3×3, a stride of 1, and a padding of 1, followed by a LeakyReLU activation. Each DoubleConvBlock may further include a 2×2 max-pooling layer and batch normalization. The DoubleConvBlocks may progressively extract features while reducing the spatial dimensions of the input.

The CFE encoder 103 may further include a projection head connected to the output of the last DoubleConvBlock. The projection head may flatten or compress a feature map from the last DoubleConvBlock into a one-dimensional vector. The projection head may then map the flattened vector to an 8-dimensional embedding vector using a multi-layer perceptron (MLP) with two hidden layers.

The output of the CFE encoder 103 may be the 8-dimensional CFE vector that captures the unique color characteristics of the camera. The CFE vector may be fixed for each camera and may only need to be generated once for a given camera.

FIG. 3 illustrates a block diagram of an example structure of the hypernetwork in one or more embodiments.

Referring to FIG. 3, the hypernetwork 106 may receive concatenated features including the uv-histograms and the CFE vector as an input 302. The hypernetwork 106 may include an encoder 304 and decoders 314 and 322.

For example, the encoder 304 may include four encoder blocks arranged sequentially. Encoder block 1 (306) may receive the concatenated features from the concatenated features input 302. Encoder block 1 (306) may be connected to encoder block 2 (308), which may be connected to encoder block 3 (310), which may be connected to encoder block 4 (312). Each encoder block may include a 3×3 convolutional layer, followed by a LeakyReLU activation, batch normalization, and 2×2 max pooling. Feature maps may be progressively downsampled through each encoder block. The feature maps from each encoder block may be stored for use by skip connections.

The hypernetwork 106 may include two parallel decoder branches. A first decoder branch, decoder 1 (314), may be configured to generate the filters F₀ and F₁, and a second decoder branch, decoder 2 (322), may be configured to generate the bias B. Decoder 1 314 may include decoder block 1-1 (316), decoder block 1-2 (318), and decoder block 1-3 (320) arranged sequentially. Decoder 2 (322) may include decoder block 2-1 (324), decoder block 2-2 (326), and decoder block 2-3 (328) arranged sequentially. Each decoder block may comprise 2× bilinear upsampling, followed by a 3×3 convolutional layer, LeakyReLU activation, and instance normalization. Skip connections, shown as dashed lines in FIG. 3, may connect encoder blocks to corresponding decoder blocks at matching resolutions. Specifically, encoder block 3 (310) may be connected via skip connections to decoder block 1-1 (316) and decoder block 2-1 (324). Encoder block 2 (308) may be connected via skip connections to decoder block 1-2 (318) and decoder block 2-2 (326). Encoder block 1 (306) may be connected via skip connections to decoder block 1-3 (320) and decoder block 2-3 (328). The skip connections may allow spatial information from the encoder to be preserved and utilized by the decoders.

The first decoder branch, decoder 1 (314), may output the filters F₀ and F₁, and the second decoder branch, decoder 2 (322), may output the bias B. The outputs may have the same spatial dimensions as the input uv-histograms (e.g., 64×64). The filters and bias may then be provided to the illuminant estimation module 107 for generating the illuminant heatmap.

The architecture of the hypernetwork 106 described herein with reference to FIG. 3 is one example instantiation, and embodiments of the present disclosure are not limited to the specific architecture shown. The hypernetwork 106 may be implemented as any network that receives the concatenated inputs and outputs per-bin parameters used to estimate the illuminant. Alternative realizations may include a compact convolutional neural network trunk with multiple output heads, a multi-layer perceptron operating on flattened histograms, or other architectures that preserve the histogram's spatial structure.

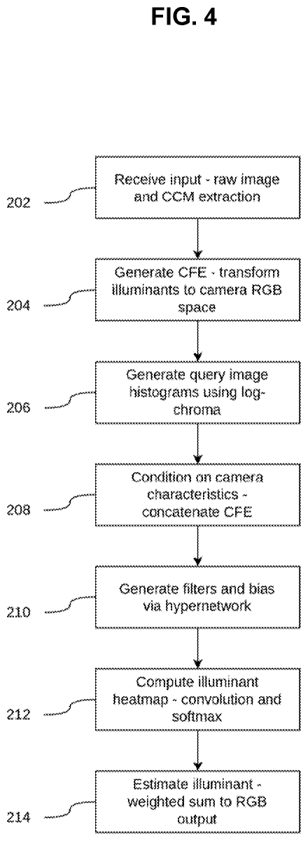

FIG. 4 illustrates a flowchart of a method for performing a cross-camera color constancy process in one or more embodiments.

Referring to FIG. 4, a flowchart illustrating a method for cross-camera color constancy is shown. The method may be performed by the cross-camera color constancy system described with reference to FIG. 1.

At step S202, the cross-camera color constancy system may receive input data. The input data may include a raw query image captured by a camera (e.g., an image sensor) and color correction matrices (CCMs) associated with the camera. Specifically, the cross-camera color constancy system may extract CCM_{low} and CCM_{high} corresponding to low and high correlated color temperatures (e.g., approximately 2500K and 6500K, respectively) for the test camera. In some aspects, no additional images from the test camera may be required beyond the single raw query image.

At step S204, the system may generate a Camera Fingerprint Embedding (CFE). This step may involve transforming a predefined set of illuminants along the Planckian locus from the CIE XYZ color space to the camera's native raw RGB space using the extracted CCMs. The transformed RGB values may then be converted into a log-chroma histogram of guidance illuminants. The histogram may be encoded into an 8-dimensional CFE feature vector using a lightweight CNN-based encoder. The CFE feature may capture unique spectral response characteristics of the camera.

At step S206, the cross-camera color constancy system may generate query image histograms. The input raw image and an edge-augmented version of the input image may be converted to log-chroma space. Two-dimensional uv-histograms N₀ and N₁ may be computed from the original image and the edge-augmented image, respectively.

At step S208, the cross-camera color constancy system may condition on camera characteristics. The CFE feature may be repeated and expanded along the u and v axes to match the resolution of the input histograms. The expanded CFE feature may then be concatenated with the image histograms along the channel dimension to form a combined feature representation.

At step S210, the cross-camera color constancy system may generate filters and bias. The concatenated features, including the histograms and the CFE feature, may be passed through a hypernetwork with an encoder and multi-decoder architecture. The hypernetwork may produce filters F₀ and F₁ and a bias B.

At step S212, the cross-camera color constancy system may compute an illuminant heatmap. The generated filters and bias may be applied to the histograms using convolution operations. A normalization operation, such as softmax, may be applied to generate an illuminant heatmap P representing a probability distribution over the uv chromaticity space.

At step S214, the cross-camera color constancy system may estimate an RGB illuminant color for the input raw query image. The expected uv-coordinates (û, \hat{v}) may be computed from the illuminant heatmap P as a weighted sum of the heatmap coordinates. The uv-coordinates (û, \hat{v}) may then be converted to an estimated illuminant RGB vector in the camera's native raw color space by inverting the log-chroma transformation. Since the log-chroma space represents relative chromaticity, the inversion yields the ratios between the color channels: I_{R}=I_{G}·exp(−û), I_{B}=I_{G}·exp(−\hat{v}). By setting a reference green channel I_{G} to a normalized value (e.g., 1.0), the cross-camera color constancy system may produce the final estimated RGB illuminant color [I_{R}, I_{G}, I_{B}]^{T} for the input raw query image.

In some aspects, the cross-camera color constancy system in one more embodiments may address limitations of prior art approaches to cross-camera color constancy. Prior art learning-based illuminant estimation methods may be inherently camera-specific, as they are trained on paired data captured by the same camera used during deployment, causing them to encode sensor-specific characteristics that limit generalization to cameras with different properties. Adapting such methods to new cameras may require retraining with newly captured and calibrated data, which may be labor-intensive and impractical at scale. Some prior art cross-camera methods may depend on the diversity of training cameras to learn a mapping to a working space, while other methods may require additional images from the test camera during inference, making their accuracy dependent on the characteristics of those additional images. In contrast, the cross-camera color constancy system may leverage pre-calibrated CCMs that are readily available in camera ISPs and DNG files to generate a camera fingerprint embedding (CFE) that enables the cross-camera color constancy system to adapt to unseen cameras without retraining and without requiring additional images from the test camera. The imaginary camera augmentation may further enhance generalization by synthesizing virtual cameras during training to broaden the range of camera raw spaces encountered.

In some aspects, the cross-camera color constancy system may provide cross-camera color constancy while remaining lightweight. The CFE vector may be fixed once the camera device is determined, and may only need to be extracted once for a new camera and reused thereafter. As a result, the size and computational cost of the cross-camera color constancy system may be determined solely by the hypernetwork 106, making it suitable for integration into ISP modules where efficient resource utilization may be beneficial.

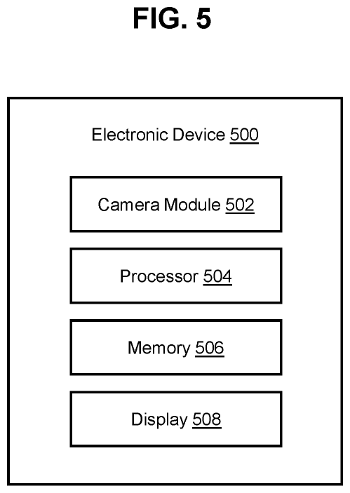

FIG. 5 illustrates an example implementation of the cross-camera color constancy system in an electronic device in one or more embodiments of the present disclosure.

Referring to FIG. 5, an example implementation of the cross-camera color constancy system in an electronic device is illustrated. An electronic device 500, such as a smartphone, may include a camera 502, at least one processor 504, a memory 506 and a display 508. The camera 502 may have an image sensor with specific spectral sensitivity characteristics, resulting in the camera having its own native raw RGB color space. The CCMNet model may be trained on images from various cameras during training, and at deployment time, the CCMNet model may adapt to the camera 502 in the electronic device 500 without retraining and without requiring additional images from that camera 502.

The camera module 502 may have pre-calibrated CCMs (CCM_{low} and CCM_{high}) stored in the ISP firmware as part of standard manufacturing calibration. The at least one processor 504 may generate a camera fingerprint embedding (CFE) from the camera's CCMs. The CFE may encode how the specific camera perceives a range of standard illuminants by transforming predefined illuminant chromaticities from the device-independent CIE XYZ color space into the camera's native raw RGB color space using the CCMs. This CFE may enable the CCMNet model to adapt to the camera's color space, even though the CCMNet model was trained on images captured by different cameras with different spectral characteristics.

During image capture, when a user captures a raw image using the camera module 502, the at least one processor may 504 receive the raw image and the CCMs from the camera module 502 based on instructions stored in the memory 506. The at least one processor 504 may generate the CFE from the CCMs, convert the raw image to a uv-histogram, combine features from a uv-histogram derived from the CFE with features from the uv-histogram derived from the raw image, and estimate the illuminant color in the camera's native raw RGB space based on the combined features. The at least one processor 504 may then apply white balance correction to the raw image based on the estimated illuminant color to produce a white-balanced image.

The display 508 may output the final white-balanced image to the user. In some aspects, the cross-camera color constancy system may provide accurate white balance without requiring the CCMNet model to be retrained for the specific camera module 502 in the electronic device 500, and without requiring additional images from the camera beyond the single raw query image being processed.

The embodiments of the present disclosure may also be applicable to other devices and applications, such as DSLR cameras, mirrorless cameras, security cameras, automotive cameras, and image editing software that processes raw image files.

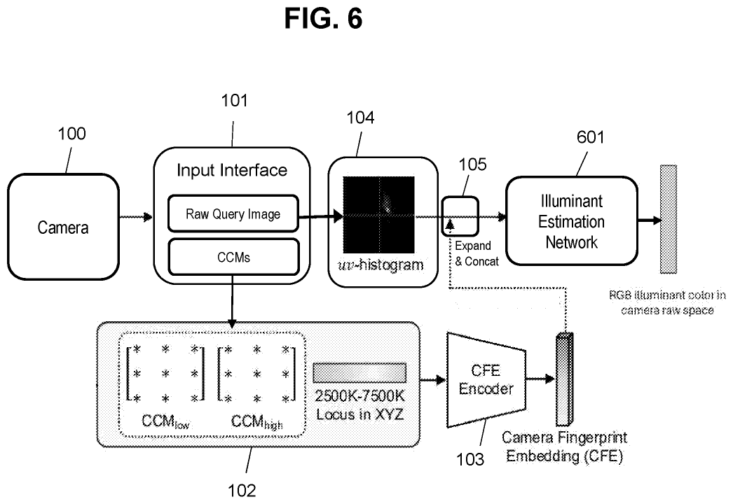

FIG. 6 illustrates a block diagram of a cross-camera color constancy system in one or more embodiments of the present disclosure.

Referring to FIG. 6, a cross-camera color constancy system may be configured with an illuminant estimation network that directly predicts the illuminant color. The cross-camera color constancy system includes the same or substantially the same front-end components as described with reference to FIG. 1: a camera 100, an input interface 101, a CCM-based illuminant trajectory generator 102, a CFE encoder 103, an image histogram converter 104, and a concatenation and feature conditioning module 105.

The input interface 101 may receive a raw query image from the camera 100 along with CCMs (CCM_{low} and CCM_{high}). The CCM-based illuminant trajectory generator 102 may receive the CCMs and may convert predefined illuminant chromaticities along the Planckian locus from the CIE XYZ color space into the native raw RGB color space of the camera using interpolation between the CCMs.

The image histogram converter 104 may receive the raw query image from the input interface 101 and may convert the raw query image into a uv-histogram representation using log-chroma mapping. The CFE encoder 103 may process the output from the CCM-based illuminant trajectory generator 102 to generate a Camera Fingerprint Embedding (CFE) that encodes the spectral response characteristics of the camera 100 into a compact representation.

The concatenation and feature conditioning module 105 may receive the uv-histogram from the image histogram converter 104 and the CFE vector from the CFE encoder 103. The concatenation and feature conditioning module 105 may expand and concatenate these inputs to form a combined feature representation.

The cross-camera color constancy system may include an illuminant estimation network model, which may be implemented using the hypernetwork 106 and the illuminant estimation module 107 described with reference to FIG. 1, or alternatively as an illuminant estimation network that directly predicts the illuminant color based on the combined feature representation received from the concatenation and feature conditioning module 105. Referring to FIG. 6, the illuminant estimation network 601 may be implemented as a Sensor-Independent Illumination Estimation (SIIE) network or similar architecture. The illuminant estimation network 601 may receive the combined feature representation from the concatenation and feature conditioning module 105 and may directly predict the illuminant color from the combined features without generating intermediate filters and bias. The output of the illuminant estimation network 601 may be the RGB illuminant color in the camera's native raw RGB color space.

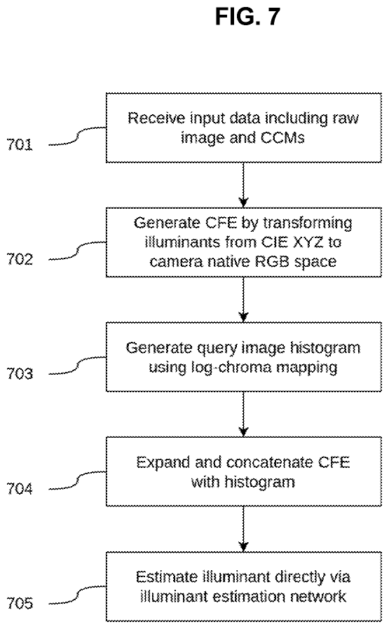

FIG. 7 illustrates a flowchart of a method for performing a cross-camera color constancy process in one or more embodiments of the present disclosure.

Referring to FIG. 7, the method may be performed by the cross-camera color constancy system described with reference to FIG. 6.

At step S701, the cross-camera color constancy system may receive input data. The input data may include a raw query image captured by an image sensor and color correction matrices (CCMs) associated with the camera. Specifically, the system cross-camera color constancy system extract CCM_{low} and CCM_{high} corresponding to low and high correlated color temperatures.

At step S702, the cross-camera color constancy system may generate a camera fingerprint embedding (CFE). This step may involve transforming a predefined set of illuminants along the Planckian locus from the CIE XYZ color space to the camera's native raw RGB space using the extracted CCMs, and encoding the transformed illuminants into a CFE vector.

At step S703, the cross-camera color constancy system may generate a query image histogram based on the raw query image. The raw query image may be converted to log-chroma space, and a two-dimensional uv-histogram may be computed from the raw query image.

At step S704, the cross-camera color constancy system may condition on camera characteristics. The CFE feature may be expanded and concatenated with the query image histogram to form a combined feature representation.

At step S705, the cross-camera color constancy system may estimate the illuminant based on the combined feature representation. The combined feature representation may be passed through an illuminant estimation network, such as a Sensor-Independent Illumination Estimation (SIIE) network, that directly predicts the illuminant color in the camera's native raw RGB space without generating intermediate filters and bias. The output may be the final estimated RGB illuminant color for the input raw image.

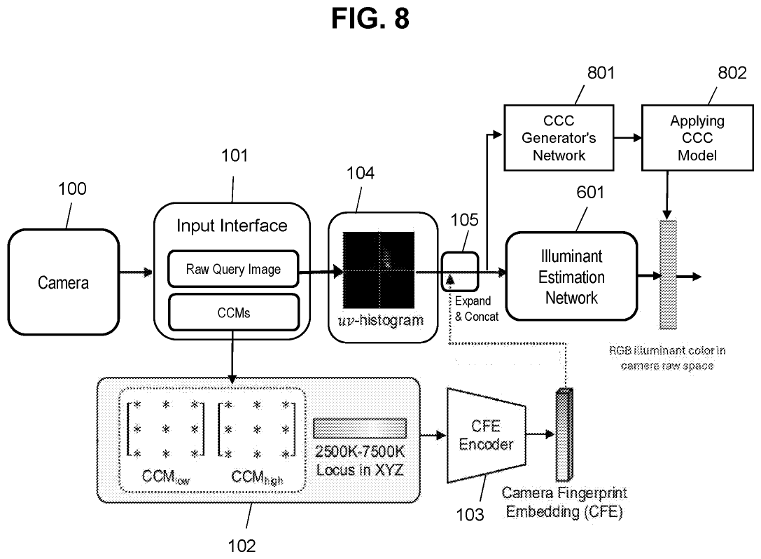

FIG. 8 illustrates a block diagram of a cross-camera color constancy system in one or more embodiments of the present disclosure.

Referring to FIG. 8, a cross-camera color constancy system may have two parallel processing paths including an illuminant estimation network and a CCC generator's network. The cross-camera color constancy system includes the same front-end components as described with reference to FIG. 1: a camera 100, an input interface 101, a CCM-based illuminant trajectory generator 102, a CFE encoder 103, an image histogram converter 104, and a concatenation and feature conditioning module 105.

The input interface 101 may receive a raw query image from the camera 101 along with CCMs (CCM_{low} and CCM_{high}). The CCM-based illuminant trajectory generator 102 may receive the CCMs and may convert predefined illuminant chromaticities along the Planckian locus from the CIE XYZ color space into the native raw RGB color space of the camera.

The image histogram converter 104 may receive the raw query image from the input interface 101 and may convert the image into a uv-histogram representation. In some aspects, the image histogram converter 104 may also generate histograms from an edge image and a texture image, providing additional input modalities.

The CFE encoder 103 may process the output from the CCM-based illuminant trajectory generator 102 to generate a Camera Fingerprint Embedding (CFE). The concatenation and feature conditioning module 105 may receive the uv-histograms from the image histogram converter 104 and the CFE from the CFE encoder 103, expanding and concatenating these inputs to form a combined feature representation.

As shown in FIG. 8, the cross-camera color constancy system may include two parallel processing paths from the concatenation and feature conditioning module 105. In a first path, an illuminant estimation network 601, which may be implemented as a Sensor-Independent Illumination Estimation (SIIE) network or similar architecture, may receive the combined features and may directly output the RGB illuminant color in the camera's native raw RGB color space.

In a second path, a CCC generator's network 801 may receive the combined features from the concatenation and feature conditioning module 105 and may generate filters and bias for a convolutional color constancy model. An applying CCC model 802 may receive the filters and bias from the CCC generator's network 601 and may apply them to estimate the illuminant color. The CCC generator's network 801 and the applying CCC model 802 may correspond to the hypernetwork 106 and illuminant estimation module 107 illustrated in FIG. 1, respectively.

Both processing paths may converge to produce the final RGB illuminant color in the camera's native raw RGB color space. The cross-camera color constancy system may select between the first path and the second path based on the desired processing approach, or may use both paths in combination.

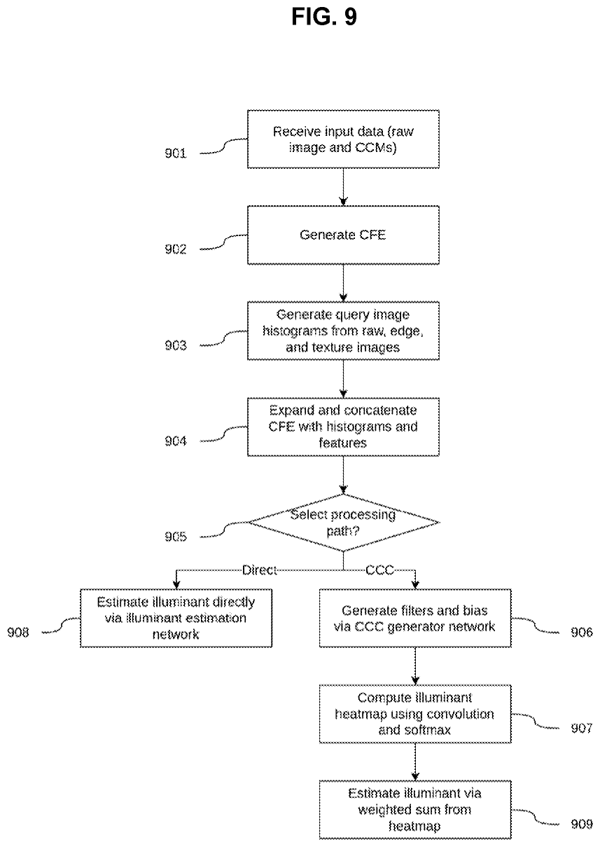

FIG. 9 illustrates a flowchart of a method for cross-camera color constancy using enriched input features and selectable processing paths as described with reference to FIG. 8.

Referring to FIG. 9, a flowchart illustrating a method for cross-camera color constancy using enriched input features and selectable processing paths is shown. The method may be performed by the cross-camera color constancy system described with reference to FIG. 8.

At step S901, the cross-camera color constancy system may receive input data. The input data may include a raw query image captured by an image sensor and color correction matrices (CCMs) associated with the camera. Specifically, the system may extract CCM_{low} and CCM_{high} corresponding to low and high correlated color temperatures.

At step S902, the cross-camera color constancy system may generate a camera fingerprint embedding (CFE). This step may involve transforming a predefined set of illuminants along the Planckian locus from the CIE XYZ color space to the camera's native raw RGB space using the extracted CCMs, and encoding the transformed illuminants into a CFE vector.

At step S903, the cross-camera color constancy system may generate query image histograms. The input raw image, an edge-enhanced version of the input image, and a texture image may be converted to log-chroma space, and uv-histograms may be computed from each. The input features may be further enriched with additional information such as raw pixel data.

At step S904, the cross-camera color constancy system may condition on camera characteristics. The CFE feature may be expanded and concatenated with the image histograms and any additional input features to form a combined feature representation.

At step S905, the cross-camera color constancy system may select a processing path. The system may select between a first path using an illuminant estimation network that directly predicts the illuminant color, or a second path using a CCC generator network that generates filters and bias.

At step S906, if the second path is selected, the system may generate filters and bias. The combined features may be passed through the CCC generator's network to produce filters and a bias for a convolutional color constancy model.

At step S907, if the second path is selected, the system may compute an illuminant heatmap. The generated filters and bias may be applied to the histograms using convolution operations, and a softmax operation may be applied to generate an illuminant heatmap representing a probability distribution over the uv chromaticity space.

At steps S908 and S909, the cross-camera color constancy system may estimate the illuminant. In the first path, the illuminant estimation network may directly predict the illuminant color from the combined feature representation at step S908. In the second path, the expected uv-coordinates may be computed from the illuminant heatmap as a weighted sum of the coordinates and converted to an estimated illuminant RGB vector at step S909. The output may be the final estimated RGB illuminant color in the camera's native raw color space.

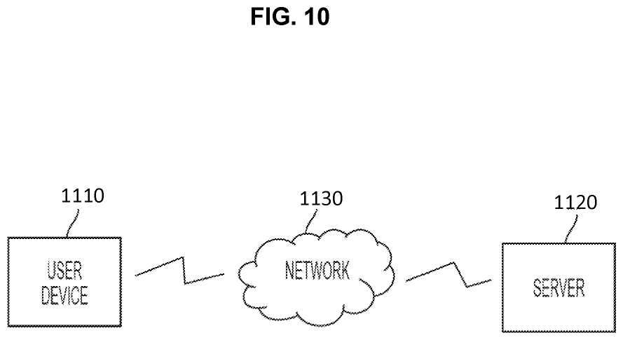

FIG. 10 illustrates a network diagram of devices for performing cross-camera color constancy according to embodiments of the present disclosure. FIG. 10 includes a user device 1110, a server 1120, and a network 1130. The user device 1110 and the server 1120 may interconnect via wired connections, wireless connections, or a combination of wired and wireless connections. The electronic device described with reference to FIG. 1 may correspond to the user device 1110 or a combination of the user device 1110 and the server 1120. For example, all or at least a part of the cross-camera color constancy system illustrated in FIG. 1, 6, or 8 may be included in the user device 1110, and the rest of the elements may be included in the server 1120.

The user device 1110 includes one or more devices configured to generate a raw output image. For example, the user device 1110 may include a computing device (e.g., a desktop computer, a laptop computer, a tablet computer, a handheld computer, a smart speaker, a server, etc.), a mobile phone (e.g., a smart phone, a radiotelephone, etc.), a camera device (e.g., the camera 100 in FIG. 1), a wearable device (e.g., a pair of smart glasses or a smart watch), or a similar device.

The server 1120 includes one or more devices configured to receive an image and perform an AI-based image processing on the image to obtain a color-transformed image, according to a request from the user device 1110.

The network 1130 includes one or more wired and/or wireless networks. For example, network 1130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 10 are provided as an example. In practice, there may be additional devices and/or networks, fewer devices and/or networks, different devices and/or networks, or differently arranged devices and/or networks than those shown in FIG. 10. Furthermore, two or more devices shown in FIG. 10 may be implemented within a single device, or a single device shown in FIG. 10 may be implemented as multiple, distributed devices. Additionally, or alternatively, a set of devices (e.g., one or more devices) may perform one or more functions described as being performed by another set of devices.

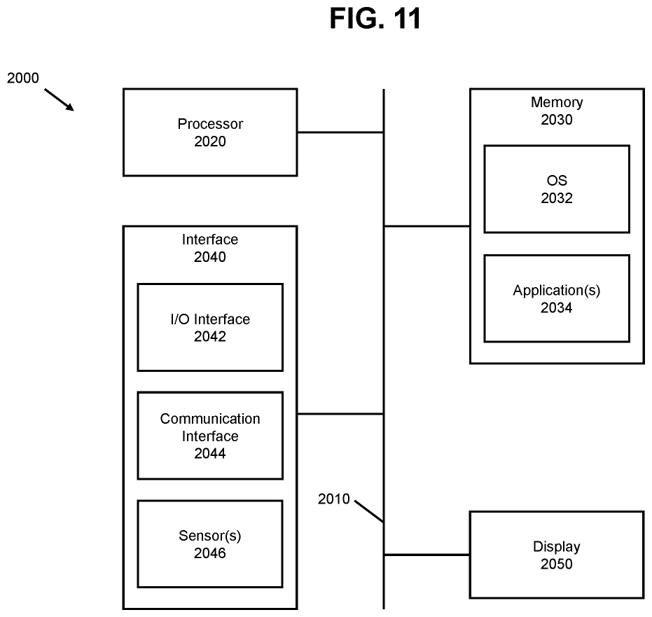

FIG. 11 illustrates a block diagram of components of one or more devices of FIG. 10 according to embodiments of the present disclosure. An electronic device 2000 may correspond to the user device 1110 and/or the server 1120.

The electronic device 2000 includes a bus 2010, a processor 2020, a memory 2030, an interface 2040, and a display 2050.

The bus 2010 includes a circuit for connecting the components 2020 to 2050 with one another. The bus 2010 functions as a communication system for transferring data between the components 2020 to 2050 or between electronic devices.

The processor 2020 includes one or more of a central processing unit (CPU), a graphics processor unit (GPU), an accelerated processing unit (APU), a many integrated core (MIC), a field-programmable gate array (FPGA), a digital signal processor (DSP), a machine learning accelerator, a neural processing unit (NPU). The processor 2020 may be a single core processor or a multi core processor. The processor 2020 is able to perform control of any one or any combination of the other components of the electronic device 2000, and/or perform an operation or data processing relating to communication. For example, the processor 2020 may perform the operations of all or part of the input interface 101, the CCM-based illuminant trajectory generator 102, the CFE encoder 103, the image histogram converter 104, the concatenation and feature conditioning module 105, the hypernetwork 106, and the illuminant estimation module 107 illustrated in FIG. 1, all or part of the input interface 101, the CCM-based illuminant trajectory generator 102, the CFE encoder 103, the image histogram converter 104, the concatenation and feature conditioning module 105, the hypernetwork 106, the illuminant estimation module 107, and the illuminant estimation network 601 illustrated in FIG. 6, or all or part of the input interface 101, the CCM-based illuminant trajectory generator 102, the CFE encoder 103, the image histogram converter 104, the concatenation and feature conditioning module 105, the hypernetwork 106, the illuminant estimation module 107, and the illuminant estimation network 601, the CCC generator's network 801, and the applying CCC model 802 illustrated in FIG. 8. The processor 2020 executes one or more programs stored in the memory 2030.

The memory 2030 may include a volatile and/or non-volatile memory. The memory 2030 stores information, such as one or more of commands, data, programs (one or more instructions), applications 2034, etc., which are related to at least one other component of the electronic device 2000 and for driving and controlling the electronic device 2000. For example, commands and/or data may formulate an operating system (OS) 2032. Information stored in the memory 2030 may be executed by the processor 2020. In particular, the memory 2030 may store original images and processed images (e.g., color transformed images).

The applications 2034 include the embodiments described herein. In particular, the applications 2034 may include programs to execute the input interface 101, the CCM-based illuminant trajectory generator 102, the CFE encoder 103, the image histogram converter 104, the concatenation and feature conditioning module 105, the hypernetwork 106, the illuminant estimation module 107, the illuminant estimation network 601, the CCC generator's network 801, and the applying CCC model 802, and to perform one or more operations discussed above. These functions can be performed by a single application or by multiple applications that each carry out one or more of these functions. For example, the applications 2034 may include a photo application. When the photo application receives a user request to take a photo, the photo application may capture a raw image using the camera module, extract the color correction matrices from the camera's ISP firmware, generate a camera fingerprint embedding from the color correction matrices, convert the raw image into a histogram representation, process the histogram and the camera fingerprint embedding through the hypernetwork 106 to estimate the illuminant color in the camera's native raw RGB color space, and apply white balance correction to the raw image based on the estimated illuminant color to produce a color transformed image. The photo application may display and store the color transformed image.

The display 2050 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 2050 can also be a depth-aware display, such as a multi-focal display. The display 2050 is able to present, for example, various contents, such as text, images, videos, icons, and symbols.

The interface 2040 includes input/output (I/O) interface 2042, communication interface 2044, and/or one or more sensors 2046. The I/O interface 2042 serves as an interface that can, for example, transfer commands and/or data between a user and/or other external devices and other component(s) of the electronic device 2000.

The communication interface 2044 may enable communication between the electronic device 2000 and other external devices, via a wired connection, a wireless connection, or a combination of wired and wireless connections. The communication interface 2044 may permit the electronic device 2000 to receive information from another device and/or provide information to another device. For example, the communication interface 2044 may include an Ethernet interface, an optical interface, a coaxial interface, an infrared interface, a radio frequency (RF) interface, a universal serial bus (USB) interface, a Wi-Fi interface, a cellular network interface, or the like. The communication interface 2044 may receive or transmit a raw image, a processed image, and a target illumination from or to an external device.

The sensor(s) 2046 of the interface 2040 can meter a physical quantity or detect an activation state of the electronic device 2000 and convert metered or detected information into an electrical signal. For example, the sensor(s) 2046 can include one or more cameras or other imaging sensors for capturing images of scenes. The sensor(s) 2046 can also include any one or any combination of a microphone, a keyboard, a mouse, and one or more buttons for touch input. The sensor(s) 2046 can further include an inertial measurement unit. In addition, the sensor(s) 2046 can include a control circuit for controlling at least one of the sensors included herein. Any of these sensor(s) 2046 can be located within or coupled to the electronic device 2000.

A color transformation method for performing cross-camera color constancy in one or more embodiments may be written as computer-executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to an electronic device, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The color transformation method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of a server.

A model related to the neural networks described above may be implemented via a software module. When the model is implemented via a software module (for example, a program module including instructions), the model may be stored in a computer-readable recording medium.

Also, the model may be a part of the electronic device described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

While the embodiments of the disclosure have been described with reference to the figures, it will be understood by those of ordinary skill in the art that various changes in form and details may be made therein without departing from the spirit and scope as defined by the following claims.

The above disclosure also encompasses the embodiments listed below:
(1) An electronic device may include: a memory storing instructions; and at least one processor configured to execute the instructions to: receive a raw image from a camera and color correction matrices (CCMs) including a first CCM corresponding to a first correlated color temperature and a second CCM corresponding to a second correlated color temperature; generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; convert the raw image into a histogram representation using log-chroma mapping; concatenate the CFE vector with the histogram representation to form a combined feature representation; and estimate an illuminant color in the raw RGB color space of the camera through an illuminant estimation neural network model based on the combined feature representation.
(2) In the electronic device according to feature (1), the at least one processor is further configured to execute the instructions to generate the CFE by computing an interpolated CCM for a target color temperature using an equation CCMₜ=g·CCM₁+(1-g)·CCM₂, wherein CCMₜ denotes the interpolated CCM, CCM₁ and CCM₂ denote the first CCM and the second CCM, respectively, and g is an interpolation weight based on reciprocals of color temperatures.
(3) In the electronic device according to feature (1), the CFE vector is generated by a convolutional neural network (CNN)-based encoder including a plurality of convolutional layers followed by a projection head.
(4) In the electronic device according to feature (1), the illuminant estimation neural network model may include a hypernetwork configured to process the combined feature representation to generate at least one filter and a bias, and wherein the at least one processor is further configured to execute the instructions to: generate an illuminant heatmap by applying the at least one filter and the bias to the histogram representation using a convolution operation and a normalization operation that produces a probability distribution, and estimate the illuminant color based on the illuminant heatmap.
(5) In the electronic device according to feature (4), the hypernetwork may include an encoder-decoder network with an encoder and a plurality of decoders, the plurality of decoders may include a first decoder configured to generate the at least one filter and a second decoder configured to generate the bias, and skip connections connect encoder may block within the encoder to corresponding decoder blocks within the plurality of decoders.
(6) In the electronic device according to feature (4), the histogram representation may include a uv-histogram, and the normalization operation is a softmax operation, the at least one processor may be further configured to execute the instructions to: estimate the illuminant color by computing expected uv-coordinates as a weighted sum of coordinates using the illuminant heatmap, and converting the expected uv-coordinates to an RGB vector by inverting a log-chroma transformation.
(7) In the electronic device according to feature (4), wherein the histogram representation may include a first uv-histogram of the raw image, and the at least one processor may be further configured to execute the instructions to: generate an edge-enhanced version of the raw image by applying an edge enhancement operation to the raw image; and convert the edge-enhanced version into a second uv-histogram. The hypernetwork is configured to generate a plurality of filters corresponding to the first uv-histogram and the second uv-histogram.
(8) In the electronic device according to feature (1), the at least one processor is further configured to execute the instructions to apply white balance correction to the raw image based on the illuminant color.
(9) In the electronic device according to feature (1), the illuminant estimation neural network model may be configured to directly predict the illuminant color from the combined feature representation without generating intermediate filters and bias.
(10) A method for cross-camera color constancy, may include: receiving a raw image from a camera and color correction matrices (CCMs) including a first CCM corresponding to a first correlated color temperature and a second CCM corresponding to a second correlated color temperature; generating a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; converting the raw image into a histogram representation using log-chroma mapping; concatenating the CFE vector with the histogram representation to form a combined feature representation; and estimating an illuminant color in the raw RGB color space of the camera through an illuminant estimation neural network based on the combined feature representation.
(11) In the method according to feature (10), the generating of the CFE may include: computing an interpolated CCM for a target color temperature using an equation CCMₜ=g·CCM₁+(1-g)·CCM₂, wherein CCMₜ denotes the interpolated CCM, CCM₁ and CCM₂ denote the first CCM and the second CCM, respectively, and g is an interpolation weight based on reciprocals of color temperatures.
(12) In the method according to feature (10), the generating of the CFE may include: generating the CFE vector using a convolutional neural network (CNN)-based encoder including a plurality of convolutional layers followed by a projection head.
(13) In the method according to feature (10), the illuminant estimation neural network model may include a hypernetwork configured to process the combined feature representation to generate at least one filter and a bias, and the method may further include generating an illuminant heatmap by applying the at least one filter and the bias to the histogram representation using a convolution operation and a normalization operation that produces a probability distribution, and estimating the illuminant color based on the illuminant heatmap.
(14) In the method according to feature (13), the hypernetwork may include an encoder-decoder network with an encoder and a plurality of decoders, wherein the plurality of decoders may include a first decoder configured to generate the at least one filter and a second decoder configured to generate the bias, and wherein skip connections may connect encoder blocks within the encoder to corresponding decoder blocks within the plurality of decoders.
(15) In the method according to feature (13), the histogram representation may include a uv-histogram, and the normalization operation is a softmax operation, and the estimating of the illuminant color may include computing expected uv-coordinates as a weighted sum of coordinates using the illuminant heatmap, and converting the expected uv-coordinates to an RGB vector by inverting a log-chroma transformation.
(16) In the method according to feature (13), the histogram representation may include a first uv-histogram of the raw image, and the method may further include: generating an edge-enhanced version of the raw image by applying an edge enhancement operation to the raw image; converting the edge-enhanced version into a second uv-histogram; and generating, via the hypernetwork, a plurality of filters as the at least one filter, wherein the plurality of filters corresponds to the first uv-histogram and the second uv-histogram.
(17) The method according to feature (13) may further include applying white balance correction to the raw image based on the illuminant color.
(18) In the method according to feature (10), the estimating of the illuminant color may include: predicting the illuminant color from the combined feature representation via the illuminant estimation neural network model without generating intermediate filters and bias.
(19) A non-transitory computer-readable storage medium storing instructions that, when executed by at least one processor, may cause the at least one processor to: receive a raw image from a camera and color correction matrices (CCMs) including a first CCM corresponding to a first correlated color temperature and a second CCM corresponding to a second correlated color temperature; generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector; convert the raw image into a histogram representation using log-chroma mapping; concatenate the CFE vector with the histogram representation to form a combined feature representation; and estimate an illuminant color in the raw RGB color space of the camera through an illuminant estimation neural network model based on the combined feature representation.
(20) In the non-transitory computer-readable storage medium according to feature (19), the illuminant estimation neural network model may include a hypernetwork configured to process the combined feature representation to generate at least one filter and a bias, and the at least one processor may be further configured to execute the instructions to: generate an illuminant heatmap by applying the at least one filter and the bias to the histogram representation using a convolution operation and a normalization operation that produces a probability distribution, and estimate the illuminant color based on the illuminant heatmap

What is claimed is:

1. An electronic device comprising:
a memory storing instructions; and
at least one processor configured to execute the instructions to:
receive a raw image from a camera and color correction matrices (CCMs) including a first CCM corresponding to a first correlated color temperature and a second CCM corresponding to a second correlated color temperature;
generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector;
convert the raw image into a histogram representation using log-chroma mapping;
concatenate the CFE vector with the histogram representation to form a combined feature representation; and
estimate an illuminant color in the raw RGB color space of the camera through an illuminant estimation neural network model based on the combined feature representation.

2. The electronic device of claim 1, wherein the at least one processor is further configured to execute the instructions to generate the CFE by computing an interpolated CCM for a target color temperature using an equation CCMₜ=g·CCM₁+(1-g)·CCM₂,
wherein CCMₜ denotes the interpolated CCM, CCM₁ and CCM₂ denote the first CCM and the second CCM, respectively, and g is an interpolation weight based on reciprocals of color temperatures.

3. The electronic device of claim 1, wherein the CFE vector is generated by a convolutional neural network (CNN)-based encoder comprising a plurality of convolutional layers followed by a projection head.

4. The electronic device of claim 1, wherein the illuminant estimation neural network model comprises a hypernetwork configured to process the combined feature representation to generate at least one filter and a bias, and
wherein the at least one processor is further configured to execute the instructions to:
generate an illuminant heatmap by applying the at least one filter and the bias to the histogram representation using a convolution operation and a normalization operation that produces a probability distribution, and
estimate the illuminant color based on the illuminant heatmap.

5. The electronic device of claim 4, wherein the hypernetwork comprises an encoder-decoder network with an encoder and a plurality of decoders,
wherein the plurality of decoders comprises a first decoder configured to generate the at least one filter and a second decoder configured to generate the bias, and
wherein skip connections connect encoder blocks within the encoder to corresponding decoder blocks within the plurality of decoders.

6. The electronic device of claim 4, wherein the histogram representation comprises a uv-histogram, and the normalization operation is a softmax operation,
wherein the at least one processor is further configured to execute the instructions to:
estimate the illuminant color by computing expected uv-coordinates as a weighted sum of coordinates using the illuminant heatmap, and converting the expected uv-coordinates to an RGB vector by inverting a log-chroma transformation.

7. The electronic device of claim 4, wherein the histogram representation comprises a first uv-histogram of the raw image, and
wherein the at least one processor is further configured to execute the instructions to:
generate an edge-enhanced version of the raw image by applying an edge enhancement operation to the raw image; and
convert the edge-enhanced version into a second uv-histogram, and
wherein the hypernetwork is configured to generate a plurality of filters corresponding to the first uv-histogram and the second uv-histogram.

8. The electronic device of claim 1, wherein the at least one processor is further configured to execute the instructions to apply white balance correction to the raw image based on the illuminant color.

9. The electronic device of claim 1, wherein the illuminant estimation neural network model is configured to directly predict the illuminant color from the combined feature representation without generating intermediate filters and bias.

10. A method for cross-camera color constancy, the method comprising:
receiving a raw image from a camera and color correction matrices (CCMs) including a first CCM corresponding to a first correlated color temperature and a second CCM corresponding to a second correlated color temperature;
generating a camera fingerprint embedding (CFE) by transforming predefined illuminant chromaticities from a device-independent color space into a raw RGB color space of the camera using interpolation between the CCMs, and encoding the transformed illuminant chromaticities into a CFE vector;
converting the raw image into a histogram representation using log-chroma mapping;
concatenating the CFE vector with the histogram representation to form a combined feature representation; and
estimating an illuminant color in the raw RGB color space of the camera through an illuminant estimation neural network based on the combined feature representation.

11. The method of claim 10, wherein the generating of the CFE comprises:
computing an interpolated CCM for a target color temperature using an equation CCMₜ=g·CCM₁+(1-g)·CCM₂,
wherein CCMₜ denotes the interpolated CCM, CCM₁ and CCM₂ denote the first CCM and the second CCM, respectively, and g is an interpolation weight based on reciprocals of color temperatures.

12. The method of claim 10, wherein the generating of the CFE comprises:
generating the CFE vector using a convolutional neural network (CNN)-based encoder comprising a plurality of convolutional layers followed by a projection head.

13. The method of claim 10, wherein the illuminant estimation neural network model comprises a hypernetwork configured to process the combined feature representation to generate at least one filter and a bias, and
wherein the method further comprises generating an illuminant heatmap by applying the at least one filter and the bias to the histogram representation using a convolution operation and a normalization operation that produces a probability distribution, and estimating the illuminant color based on the illuminant heatmap.

14. The method of claim 13, wherein the hypernetwork comprises an encoder-decoder network with an encoder and a plurality of decoders,
wherein the plurality of decoders comprises a first decoder configured to generate the at least one filter and a second decoder configured to generate the bias, and
wherein skip connections connect encoder blocks within the encoder to corresponding decoder blocks within the plurality of decoders.

15. The method of claim 13, wherein the histogram representation comprises a uv-histogram, and the normalization operation is a softmax operation, and
wherein the estimating of the illuminant color comprises computing expected uv-coordinates as a weighted sum of coordinates using the illuminant heatmap, and converting the expected uv-coordinates to an RGB vector by inverting a log-chroma transformation.

16. The method of claim 13, wherein the histogram representation comprises a first uv-histogram of the raw image, and
wherein the method further comprises:
generating an edge-enhanced version of the raw image by applying an edge enhancement operation to the raw image;
converting the edge-enhanced version into a second uv-histogram; and
generating, via the hypernetwork, a plurality of filters as the at least one filter, wherein the plurality of filters corresponds to the first uv-histogram and the second uv-histogram.

17. The method of claim 13, further comprising applying white balance correction to the raw image based on the illuminant color.

18. The method of claim 10, wherein the estimating of the illuminant color comprises:
predicting the illuminant color from the combined feature representation via the illuminant estimation neural network model without generating intermediate filters and bias.

19. A non-transitory computer-readable storage medium storing instructions that, when executed by at least one processor, cause the at least one processor to:
receive a raw image from a camera and color correction matrices (CCMs) including a first CCM corresponding to a first correlated color temperature and a second CCM corresponding to a second correlated color temperature;
generate a camera fingerprint embedding (CFE) by transforming predefined illuminant chromaticities from a device-independent color space into a raw RGB color space of the camera using interpolation between the CCMs, and encoding the transformed illuminant chromaticities into a CFE vector;
convert the raw image into a histogram representation using log-chroma mapping;
concatenate the CFE vector with the histogram representation to form a combined feature representation; and
estimate an illuminant color in the raw RGB color space of the camera through an illuminant estimation neural network model based on the combined feature representation.

20. The non-transitory computer-readable storage medium of claim 19, wherein the illuminant estimation neural network model comprises a hypernetwork configured to process the combined feature representation to generate at least one filter and a bias, and
wherein the at least one processor is further configured to execute the instructions to:
generate an illuminant heatmap by applying the at least one filter and the bias to the histogram representation using a convolution operation and a normalization operation that produces a probability distribution, and
estimate the illuminant color based on the illuminant heatmap.
